(19) United States
(12) Patent Application Publication
(10) Pub. No.: US 2002/0078077 A1
(43) Pub. Date: Jun. 20, 2002

(54) Expiration informer

(76) Inventors: Cliff Baumann, San Jose, CA (US); Brett Francis, Redwood City, CA (US)

Correspondence Address: James S. Hsue, Skjerven Morrill MacPherson LLP, Suite 700, 25 Metro Drive, San Jose, CA, 95110, US

(21) Appl. No.: 09/741,641

(22) Filed: Dec. 19, 2000

(51) Int. Cl. G06F 12/00

(52) U.S. Cl. 707/206

(57) ABSTRACT

The invention uses expiration notification events and object references to indicate when a software object has expired. Expiration notification events are occurrences that indicate when corresponding object references and dependent references should be removed. Object references and dependent references are references to objects within the computer memory. Using the object management methods of the Expiration Informer, the object references are stored in a table according to the objects' expiration time. Upon expiration, the managed object is removed from the table and stored in an expiration event. The expiration event is sent to the requester at which time the Expiration Informer has removed any reference to the object. The invention is capable of managing objects is a distributed computing environment. The invention executes these capabilities in an extremely efficient manner adding minimal CPU overhead when managing thousands of time-based objects.

### FIELD OF THE INVENTION

The invention relates to managing software objects that expire according to time as well as de-allocating allocated software objects from the originating source.

### BACKGROUND OF THE INVENTION

When applications executing on computers seek to refer to resources, the computers must first allocate or designate resources so that the applications can properly refer to them. When the applications no longer refer to a resource, the computers can de-allocate or reclaim the resource for reuse. Thus, resource management involves allocating resources (such as memory) in response to requests as well as de-allocating resources at appropriate times, such as when the requestor no longer required the resources.

Resource management is simple for a single computer since the events indicating when resources can be reclaimed, such as when applications no longer refer to them or after a power failure, are easy to determine. Resource management for distributed systems connecting multiple computers is more difficult because applications in several different computers may be using the same resource. Communication problems in distributed systems can lead to improper and premature reclamation of resources or to the failure to reclaim resources. Thus, if multiple applications operating on different computers in a distributed system refer to resources located on other machines, the resources may be reclaimed prematurely if there is an interruption in communication. On the other hand, resources may be maintained indefinitely due to disconnects in the distributed systems despite the fact that the resource has not been accessed for long time periods.

A system known as “distributed garbage collection” has been developed to manage network resources in distributed systems. In general, garbage collection uses the notion that resources can be freed for future use when they are no longer referenced by any part of an application. Distributed garbage collection extends this notion to the realm of distributed computing, reclaiming resources when no application on any computer refers to them.

Distributed garbage collection must maintain integrity between allocated resources and the references to those resources. In other words, the system must not be allowed to de-allocate or free a resource when an application running on any computer in the network continues to refer to that resource. Distributed systems using garbage collection must also reclaim resources no longer being referenced in the near future. In other words, the system must provide a guarantee against “memory leaks.” A memory leak can occur when all applications drop references to a resource, but the system fails to reclaim the resource for reuse because of an incorrect determination that some application still refers to the resource.

The above problem is exacerbated for systems that manage objects that have expiration times. At many websites today, a large number of web sessions may be initiated by users at times of their choice. Server resources must be allocated to service such sessions. These web sessions can be subject to many different interruptions. On the other hand, some users may become distracted and not complete the sessions. For these reasons, time limits are typically set for the web sessions so that when the time limit expires, the server resources allocated may be freed for other purposes. A failure to properly manage the web sessions can have dire consequences for the web servers. Thus, multiple “memory leaks” can result from the failure to reclaim server resources dedicated to sessions that have expired due to disruption in communication or user's actions or inaction. On the other hand, premature reclamation of server resources can result in customer dissatisfaction and loss of business.

A number of approaches have been proposed to maintain the integrity between allocated resources and the references to those resources, referred to as “referential integrity.” In one approach, a count is maintained of the number of applications referring to each resource. When the resource's count goes to zero, the garbage collection system may reclaim the resource. In U.S. Pat. No. 6,081,813 to Wollrath et al., another approach is proposed where the parties in the distributed system agree that the resource and the reference to that resource will be guaranteed for a lease period. At the end of the lease period, the guarantee that the reference to the resource will continue elapses, allowing the garbage collection system to reclaim the resource. None of these approaches are intended for managing software objects having expiration times.

It is therefore desirable to provide a system for managing time-based software objects efficiently to reduce the overhead of using objects such as web sessions.

### SUMMARY OF THE INVENTION

This invention is based on the observation that instead of having to examine and expire each and every software object, the software objects are grouped together by their expiration times and their expiration handled in groups. Thus, if the expiration times of a number of software objects fall within a time interval, they may be held in a container corresponding to such time interval. At or near the end of the time interval of the container, all of the references to the objects in the container may be removed. In this manner, the expiration of a large number of objects may be easily controlled without much overhead.

In a distributed environment, each application or computer may employ the same method to control the expiration of software objects so that no communication between applications or computers is required for expiration control. In this manner, network failures will not significantly affect expiration control.

The invention eliminates the need for an Application to determine when time based software objects expire. The result is that an Application does not need to look inside an object to determine if it has expired every time it uses it. This significantly reduces the overhead of using such an object as well as greatly simplifies the code necessary to interact with the object.

The invention incorporates an algorithm for managing the objects that is extremely efficient and is covered by this patent.

While the above-described features may be implemented as features of an integrated system, it is possible for existing computer equipment and software components to be modified or otherwise enabled so that they have the capability described above. Thus, the above-described features may be embodied as a program of instructions executable by computer to perform the above-described different aspects of the invention. Hence any of the techniques described above may be performed by means of software components loaded into a computer, appliance or device and integrated with other software components to perform the above-described functions. When so enabled, the computer, appliance or device may then perform the above-described techniques. The software component may be loaded from a fixed media or accessed through a communication medium such as the internet or any other type of computer network.

### BRIEF DESCRIPTION OF THE DRAWINGS

The accompanying drawings, which are incorporated and constitute a part of the specification, illustrate the invention and, together with the description, serve to explain the advantages and principles of the invention. In the drawings,

FIG. 1 is a flow diagram of the steps performed by the Application to enter a software object into the Expiration Informer.

FIG. 2 is a flow diagram of the steps performed by the Expiration Informer to enter a software object into the managed set of objects.

FIG. 3 is a flow diagram of the steps performed by the Application to remove a software object from the Expiration Informer and the originating server.

FIG. 4 is a flow diagram of the steps performed by the Application or the Expiration Informer to remove a software object from the Expiration Informer.

FIG. 5 is a flow diagram of the steps performed by the Application to extend (or lengthen) the amount of time that the Expiration Informer will manage the software object.

FIG. 6 is a flow diagram of the steps performed by the Expiration Informer to determine which software objects have expired and what action is taken.

FIG. 7 is a diagram of the steps performed by the Application and Resource Server according to an implementation of the present invention. It demonstrates the use of the Expiration Informer in a distributed computing environment.

For simplicity in description, identical components are labeled by the same numerals in this application.

### DETAILED DESCRIPTION OF THE PREFERRED EMBODIMENTS

Described below are embodiments involving an apparatus and method for efficiently managing a plurality of time based software objects sending guaranteed notification when the objects expire so object references can be reliably removed. In these embodiments, an Application is implemented such that it preferably incorporates a Listener (callback) to receive events from the Expiration Informer when the time-based software objects expire. Within the Listener, all references to the object are removed so the memory can be freed by the operating system. In addition, optionally, in case it is desirable to expire an object before its expiration time, the source of the software object can be notified so it can remove its reference prior to its instance of the object expiring.

The Expiration Informer (EI) is an apparatus to manage software objects that expire relative to time. An object can be submitted to the Expiration Informer with duration-to-live and a Listener (callback). Upon expiration, the Listener is notified with an expiration event that contains the original managed object. Presumably, a reference to the object is stored by the application for use while the object is valid. To free this memory, the application can simply compare the expired object to the stored object and then remove its references to the stored object. This will result in all references to the object being removed.

Another aspect of the Expiration Informer is its ability to efficiently manage time-based objects in a distributed computing environment. There is no need to increase network traffic when an object expires in the application in a distributed computing environment. The implementation behind this is the Resource Server has its own Expiration Informer to manage its instance of the object and the objects expire around the same time.

Once an object has been added to the Expiration Informer, it is not interacted with by the Expiration Informer until it is time to notify the applications' Listener of the expiration event. This infers that the managed set of objects can grow as large as the memory available in the system limited only by the CPU time to add and expire the objects. Specifically, this means that whether there are a thousand managed objects or a million managed objects, as long as the same number of objects are being added and expired at the same rate, the CPU load will remain the same.

Reference will now be made in detail to an implementation of the present invention as illustrated in the accompanying drawings. Wherever possible, the same reference numbers will be used throughout the drawings and the following description to refer to the same or like parts.

A. Overview

An Expiration Informer (EI) component resides in each computer that needs to manage time-based software objects. These objects can be web sessions or any other types of software objects with expiration times.

In general, whenever an application obtains a reference to a time-based object, it adds it to the El as well as stores a reference for later use. Storing the reference is where the problem begins and what the invention addresses. For example, suppose an application stores an object into an array that can be identified and used at a later time. If the application does not continually poll the array looking for expired objects, the object could reside in the array indefinitely resulting in a memory leak or worse, a resource leak. The El addresses this problem by notifying the application when the object has expired. The application can then simply look for the object in its array and remove the reference.

This patent also covers the mechanism for determining when to expire objects. Since polling an array of objects to determine which have expired within the El would be just as inefficient as polling an array by the application, a more efficient algorithm was designed and incorporated into this invention.

B. Procedure

1. Creating and Adding Software Objects to the Expiration Informer

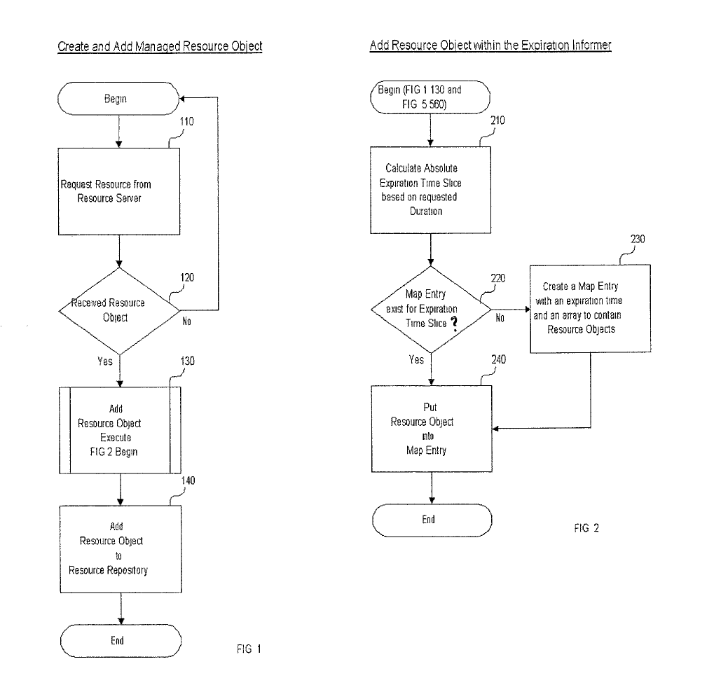

FIG. 1 is a flow diagram of the procedure to add a software object to the EI and to the application itself. This can happen such as when a user signs on and starts a web session.

After an application has obtained a reference to a time-based object such as a web session (step 110), the application adds it to the EI (step 130) passing an optional duration along with a Listener (callback) address. The object itself contains its duration, however, the application can choose to shorten the amount of time the object valid.

The application is then free to use the object until it has expired.

2. Adding Software Objects within the Expiration Informer

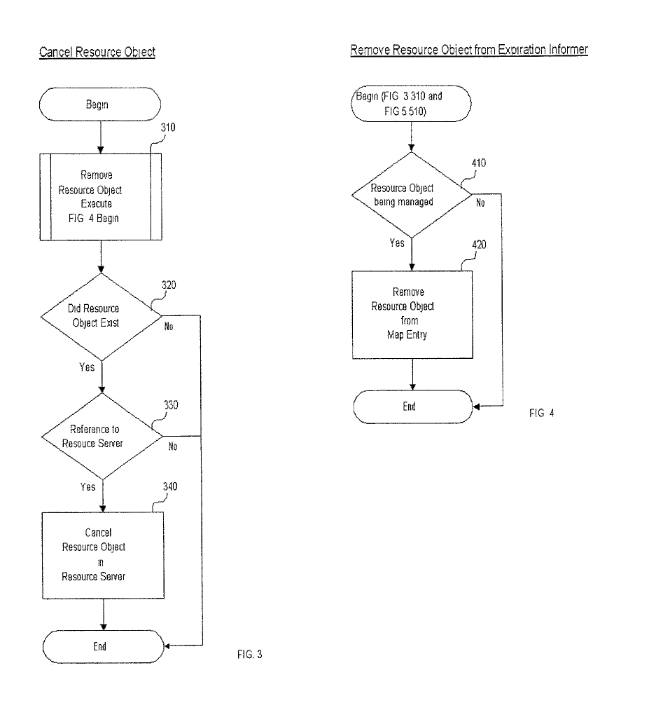

FIG. 2 is a flow diagram of the procedure to determine where the EI will store the object. The object is stored in a table (step 230). The table to store the objects within the EI is implemented as a mapping between an expiration time and an array of objects. The objects are stored into an array that represents a time slice since the Epoch, which is reference time preferably used by all the arrays. A time slice is referred to as an interval. The identifier for the map entry is the expiration time. The value of the map entry is the array of objects that expire within that interval. This mapping can be a hash table, where the key is the time interval, and its corresponding value the array containing all objects with expiration times within the time interval. Alternatively, the mapping can be implemented as a linked list where at least one of the references is a pointer to an object in a linked list that includes all of the objects in one of the containers that corresponds to said at least one reference. More generally, the mapping relation between the reference and the array of objects with expiration times falling within the time interval that corresponds to the reference can be viewed as the mapping between a reference and a corresponding container, with a corresponding time interval, containing all objects that expire within the time interval.

For efficiency purposes, the objects are stored in the array that represents the interval in which the object will expire. The expiration time is calculated upon submission to the EI and the object is placed in the appropriate array (step 210).

A map between the expiration time and an array, instead of only an array, is used for efficiency purposes. Not every interval since the Epoch or until the “end of time” will contain objects to be managed, so a slot within the map for an unused interval need not exist.

An array for the interval is used to store the objects. A single array to store all objects for every interval is not used for efficiency purposes because it is very CPU intensive to resize an array when objects are removed. The potential for resizing the array at every interval would severely impede system performance as the number of managed objects grows. Instead, a unique array exists for every interval that contains a managed object. This mechanism allows for the objects in a particular interval to be efficiently expired by sending an expiration notification event to the requester. The reference for that interval in the mapping is then removed, thus also removing all references to the managed objects for that interval within the EI.

The interval is another key component to the mechanism since it defines a window of time for which objects are grouped. The larger the interval the fewer number of unique arrays (or map entries) need to exist, however, the larger the interval, the less accurate the expiration times will be. The interval defines the accuracy of the expiration time of the object. The accuracy of the expiration time for a managed object is ±1 interval.

3. Canceling Software Objects in Expiration Informer

FIG. 3 is a flow diagram of the procedure to cancel an object in the EI. An application ask the EI to remove its reference to the object prior to the expiration time of the object itself. The EI removes the reference to the object from the array the object is stored (step 310). The EI then checks if the object has a reference to the Resource Server (steps 320, 330), or the server that created the original object, and if so, it invokes the method on the Resource Server to remove (step 340) the object from the server. This results in it releasing the resources earlier, thus providing for a more efficient use of resources.

4. Removing Software Objects within Expiration Informer

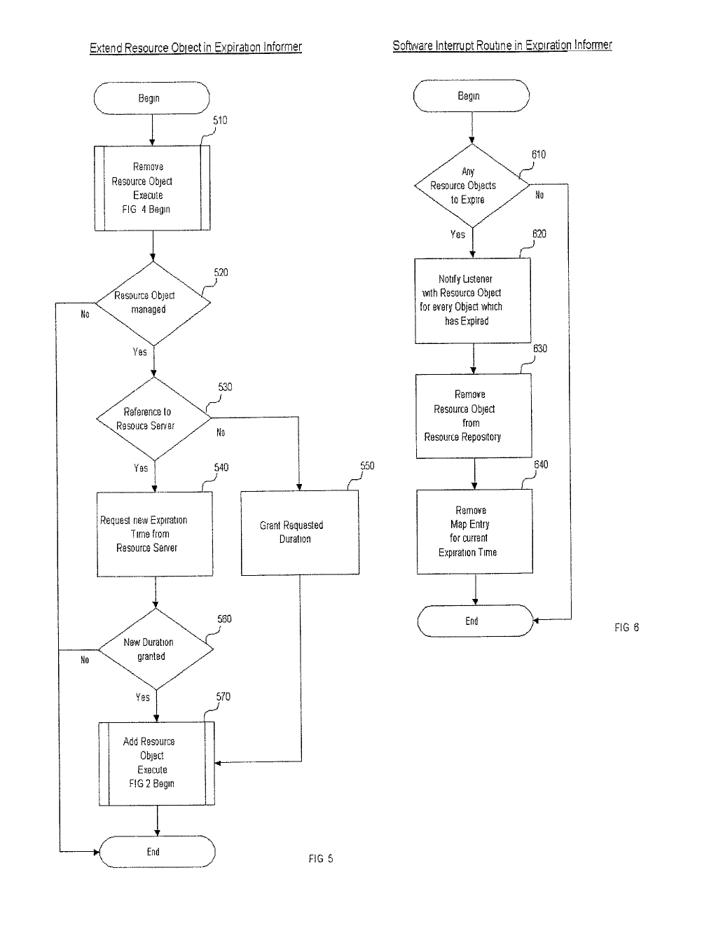

FIG. 4 is a flow diagram of the procedure to remove an object within the EI (steps 410,420).

5. Extending Software Objects in Expiration Informer

FIG. 5 is a flow diagram of the procedure to extend the expiration of an object in the EI. The object is first removed from the managed set (step 510). A new duration is requested from the Resource Server if the object has a reference to the server. The object is then re-added (steps 520, 530, 560, 570) to the EI with the new duration. Where the Resource Server has a reference to the object, the new duration is obtained from the Resource Server (step 540); otherwise the Application assigns a new duration (step 550) and adds to the EI.

6. Software Interrupt Routine in Expiration Informer

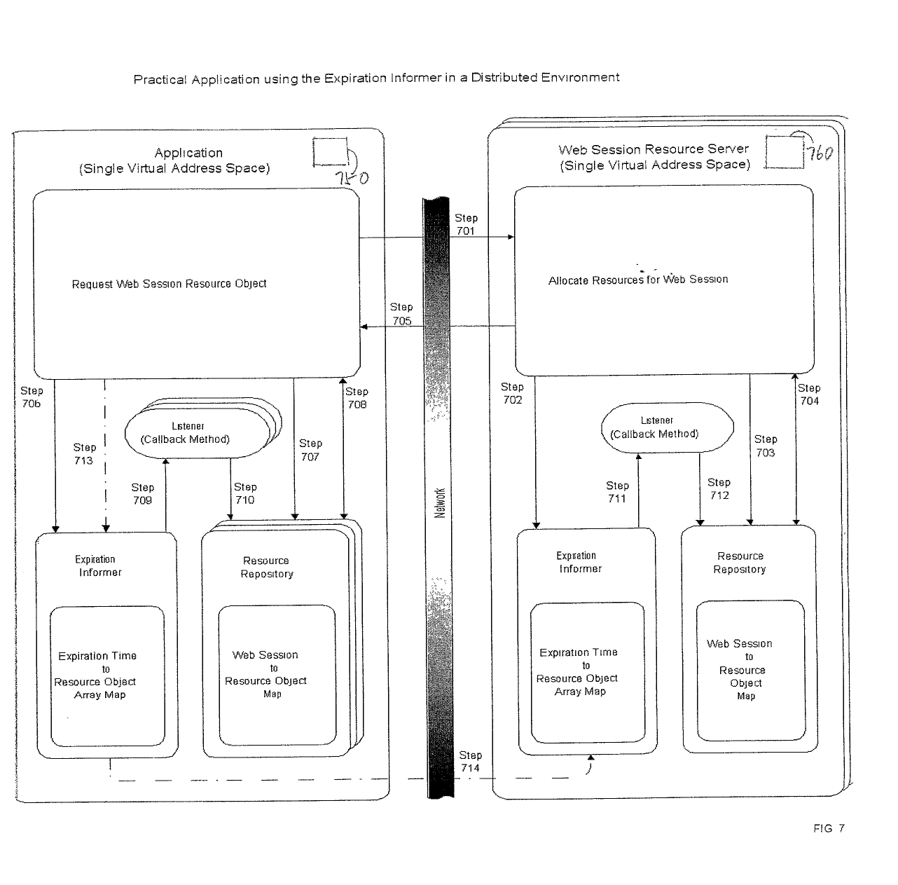

FIG. 6 is a flow diagram of the software interrupt routine used to expire objects.

The EI allocates one thread per system process to maintain the state of the table (FIG. 6). This thread can be thought of as an Interrupt Routine that runs every interval. It is solely responsible for sending an expiration notification event to the listener (step 620) provided by the requester when the object was submitted (step 130) and removing the interval key (step 640) from the map which results in removing the reference to the array of objects for that interval. A single thread to manage the time-based objects eliminates software synchronization issues as well as minimizes system resources, which contribute significantly to the efficiency of the Expiration Informer.

7. Practical Application using the Expiration Informer

FIG. 7 is a diagram of a typical application using the Expiration Informer (EI) in a distributed computing environment. The Resource Repository and Listener within the Application such as a web server is diagrammed to demonstrate that the Application needs only one instance of the EI for any number of Resource Repository types. The Resource Server (e.g. central server forming a back end supporting multiple front end web servers that interface with customers and other users) is diagrammed to demonstrate that an Application can request Resource Objects from any number of Resource Servers.

The Application requests access to a resource on the Resource Server (step 701). The Resource Server allocates the necessary resources for the Resource Object (RO), such as a web session. The Resource Server submits the RO to its Expiration Informer (El) along with a reference to its Listener as well as the duration the RO should be managed by the EI in the Resource Server (step 702). The Resource Server submits the RO to the Resource Repository where it is stored for use by the Resource Server (step 703). At this point, the Resource Server can use the RO in the Resource Repository and the resources pointed to by the RO until it is expired via the EI (step 704). The Resource Server returns a RO to the Application (step 705).

The Application submits the RO to its EI along with a reference to its Listener as well as the duration the RO should be managed by the EI (step 706). The Application submits the RO to the Resource Repository where it is stored for use by the Application (step 707); the RO points to resources available to the Application. At this point, the Application can use the RO from the Resource Repository until it is expired via the El (step 708).

The EI within the Application will expire all of the ROs when the duration or time interval of the container at the EI has or is about to expire by removing its reference to the object and sending the RO to the Listener (step 709). The Listener then invokes a remove method on the Resource Repository passing the Resource Object (step 710). At this point, the EI and the Resource Repository have no references to the RO and the system memory or other resources within the Application is freed.

The EI within the Resource Server will expire the RO when the duration has expired by removing its reference to the object and sending the RO to the Listener (step 711). The Listener then invokes a remove method on the Resource Repository passing the Resource Object (step 712). At this point, the EI and the Resource Repository have no references to the RO and the system memory within the Resource Server is freed.

Optionally, the Application can cancel or extend the duration of the RO within the El by invoking its corresponding methods and passing the RO (step 713). If the cancel or extend methods are invoked on the Applications EI, the EI will account for the change and propagate the requested change to the Resource Server's EI (step 714). A more detailed account of this process is found above in reference to FIGS. 3-5.

8. Performance of the Expiration Informer

Performance numbers were generated and produced the following results defined by the following criteria. The resulting performance was over 400 times more efficient than using a prescribed method of storing every managed object within the same array regardless of its expiration time.

Interval: the test was conducted with an interval of 30 seconds. The interval defines the accuracy of the expiration time of the object. The accuracy of the expiration time of a managed object is ±1 interval.

Performance: able to sustain managing any number of objects while adding 1000 objects per second (step 130) from the managed set and removing 30,000 objects every interval (FIG. 6) from the managed set in one process space. The total number of objects is limited only by the amount of memory within the computer. During the testing phase, there were 1,000,000 objects being managed by the Expiration Informer, however, that number could be very conservative given enough memory. It is important to note that the performance numbers were generated in a non-distributed usage of the EI. This was done to demonstrate the efficiency of the EI in a single computing environment.

System: 400 mhz Pentium II 128 megabytes of RAM running Windows NT 4.0 SP3, Java version “1.2.2” Classic VM (build JDK-1.2.2-W, native threads, symcjit)

CPU usage:

averaged 8.45% while adding 1000 objects per second and removing none.

averaged 11.06% while adding 1000 objects per second, removing 30,000 every interval and managing 1,000,000 objects.

averaged 2.31% while removing 30,000 objects every interval and adding none.

From the above, it will be evident that the purpose of the invention has been achieved. Thus, in reference to FIG. 7, for example, the Application can be one of many web servers interfacing with a large number of customers or other users and serves as the front end of a whole web-based system servicing customers and users. The Web Session Resource Server and other servers like it can be the back end of the system and provide the necessary resources to support the web sessions conducted by the web servers. Each Web Session Resource Server may support a large number of web servers. While front end servers have some resources available, most of the resources at front end servers are taken up for interfacing with users. For many of the services to be provided by the web servers, resources available at the Web Session Resource Servers need to be tapped. Thus, when a particular web session conducted by the Application requires a resource available at the Web Session Resource Server, the application will notify the Web Session Resource Server to gain access to such resource. For this reason, there must be communication between the Application and the Web Session Resource Server. The resource object (RO) is employed for this purpose.

In this context, the RO can simply be a reference or identifier pointing to a particular web session. The resource repository of the Application stores therein a list of the RO's, each RO pointing to one or more resources available to the Application for these sessions. The EI in the application A stores therein a number of containers each having a time interval, where each container contains ROs that are references or identifiers to web sessions that expire within the time interval of such container. Thus, the EI will need to keep track of only the time intervals of the containers. The time intervals are calculated from a reference time common to all the containers referred to above as the Epoch. Thus, the time intervals will form a time sequence from the Epoch, where there may be gaps between the time intervals if no web session expires during such time gap. The EI would need to keep track only of the time intervals of the containers. At or near the end of the time interval of a corresponding container, the reference to the container and all references to the objects in the container are removed by the EI. Thus, where the Application is a web server, the resource objects in the EI may be identifiers of these sessions and remove the reference to all web sessions.

As described above, the EI also sends to the Listener the ROs that have expired. In the context of the application being a web server, the ROs may be identifiers of web sessions. The Listener then invokes methods on the Resource Repository to remove the same references or identifiers in the Repository, thereby freeing the resources pointed to by these references or identifiers.

By essentially the same process, the EI and the Listener of the Web Session Resource Server manages its own ROs, and the resources pointed to by these ROs.

As will be understood in the art, the inventive software components described above may be embodied in a fixed media program component containing logic instructions and/or data that when loaded into an appropriately configured computing device to cause that device to perform according to the invention. As will be understood in the art, a fixed media program may be delivered to a user on a fixed media for loading in a user's computer or a fixed media program can reside on a remote server that a user accesses through a communication medium in order to download a program component. Thus another aspect of the invention involves transmitting, or causing to be transmitted, the program component to a user where the component, when downloaded into the user's device, can perform any one or more of the functions described above.

In systems using JAVA, garbage collection is an inherent feature, so that no extra effort is required for such feature. Where the system uses C or other languages where garbage is not an inherent feature, it is advantageous to employ such a garbage collection system which frees resources not pointed to by any reference in the system, whether or not the system is distributed. This is illustrate in FIG. 7 as box 750 for the Application, and box 760 for the Web Session Resource Server. The relation between system 750 and other functional blocks in FIG. 7 have been omitted to simplify the figure, since such relation is well known and need not be described here.

While the invention has been described above by reference to various embodiments, it will be understood that changes and modifications may be made without departing from the scope of the invention, which is to be defined only by the appended claims and their equivalents. All references referred to herein are incorporated by reference in their entirety.

What is claimed is:

1. A method for controlling expiration of a plurality of objects in a computing environment, each object having an expiration time and a reference, comprising:
providing a sequence of time intervals;
providing one or more containers, each container having a corresponding container reference, a corresponding time interval in the sequence and containing all objects with expiration times that fall within the corresponding time interval of such container; and
removing the container reference of at least one of the plurality of containers and of the references of all the objects in said at least one container at or near the end of the corresponding time interval of said at least one container.

2. The method of claim 1, wherein said environment includes a garbage collection system, wherein removing the references to the objects causes to be freed, by the garbage collection system, system resources in the environment referred to by all objects whose references have been removed.

3. The method of claim 1, wherein at least one of said container references is a key in a hash table referring to a value in the table, said value being an array storing all of the objects in one of the containers that corresponds to said at least one reference.

4. The method of claim 1, wherein at least one of said container references is a pointer to an object in a linked list that includes all of the objects in one of the containers that corresponds to said at least one container reference.

5. The method of claim 1, further comprising updating the expiration time of one or more objects.

6. The method of claim 5, wherein said updating includes removing the one or more objects and references thereto from one or more of the container(s), and obtaining a reference referring to each of the one or more objects with updated expiration times.

7. The method of claim 6, said environment including a resource component, said method further comprising checking whether the one or more objects have reference(s) to the resource component, and requesting from the resource component an updated expiration time for each of the one or more objects when such reference(s)) to the resource component exist so that the one or more objects with updated expiration times fall within time interval(s) of containers different from the one or more containers.

8. The method of claim 1, said environment including a resource component, said method further comprising removing an object in one of the containers, checking whether such object has a reference at the resource component, and causing such reference of such object at the resource component to be removed when such reference exists.

9. The method of claim 1, further comprising supplying a listener with information concerning expiration of time intervals of the containers.

10. The method of claim 9, wherein said supplying is performed by a thread.

11. The method of claim 9, wherein said supplying is performed by an interrupt routine that sends an interrupt to the listener during each time interval.

12. The method of claim 9, said objects also located in a repository, further comprising causing the listener to remove reference(s) of objects in the repository at or near the ends of time intervals of containers in the repository containing such objects.

13. The method of claim 12, said causing being performed by an expiration informer that tracks the expiration of the containers by reference to expiration of the time intervals of the containers.

14. The method of claim 9, wherein the expiration information is supplied at or near the expiration of the time intervals of the containers.

15. An apparatus for controlling expiration of a plurality of objects in a computing environment, each object having an expiration time, comprising:
a resource repository storing one or more containers, each container having a corresponding reference, a corresponding time interval in a sequence of time intervals and containing all objects with expiration times that fall within the corresponding time interval of such container; and
a first component that removes the reference of at least one of the containers and all references of objects in the at least one container at or near the end of the corresponding time interval of such container.

16. The apparatus of claim 15, further comprising a garbage collection system, wherein said component causes the system to free resources in the environment referred to by all objects within each container whose reference has been removed.

17. The apparatus of claim 15, wherein at least one of said container references is a key in a hash table referring to a value in the table, said value being an array storing all of the objects in one of the containers that corresponds to said at least one reference.

18. The apparatus of claim 15, wherein at least one of said container references is a pointer to an object in a linked list that includes all of the objects in one of the containers that corresponds to said at least one reference.

19. The apparatus of claim 15, wherein the first component updates the expiration time of one or more objects.

20. The apparatus of claim 19, wherein the first component performs said updating by removing the one or more objects and references thereto from one or more of the container(s), and obtaining a reference referring to all objects with updated expiration times.

21. The apparatus of claim 20, said environment including a resource component, wherein said first component checks whether the one or more objects have reference(s) to the resource component, and requests from the resource component an updated expiration time for each of the one or more objects when such reference(s) exist so that the one or more objects with updated expiration times fall within time interval(s) of containers different from the one or more containers.

22. The apparatus of claim 15, said environment including a resource component, wherein said first component removes an object in one of the containers, checks whether such object has a reference at the resource component, and causes such reference of such object at the resource component to be removed when such reference exists.

23. The apparatus of claim 15, further comprising a listener, wherein the first component supplies the listener with information concerning expiration of time intervals of the containers.

24. The apparatus of claim 23, wherein the first component performs said supplying under the control of a thread or using an interrupt routine that sends an interrupt to the listener during each time interval.

25. The apparatus of claim 23, further comprising a repository having said objects with expiration times that fall within corresponding time intervals of such containers, wherein the listener causes to be removed reference(s) of objects in the repository upon expiration of time intervals of containers containing such objects.

26. The apparatus of claim 23, wherein the first component causes the listener to supply the expiration information at or near the ends of the time intervals of the containers.

27. A system in an environment providing computing resources to users employing a plurality of objects, each object having an expiration time, comprising:
a first application with access to a first resource repository storing one or more of said objects;
a first expiration informer that tracks the one or more objects in the first repository by means of a first set of containers, each of the containers in the first set having a corresponding reference, a corresponding time interval in a sequence of time intervals and containing all objects with expiration times that fall within the corresponding time interval of such container;
wherein said first expiration informer tracks time intervals of the first set of containers and causes to be removed the reference of at least one of the containers in the first set and the references to the objects in such container and located in such repository at or near the end of the corresponding time interval of such container;
at least one additional application with access to at least one additional resource repository storing one or more objects; and
at least one additional expiration informer that tracks the one or more objects in the at least one additional repository by means of at least one additional set of containers, each container in the at least one additional set having a corresponding reference, a corresponding time interval in a sequence of time intervals and containing all objects with expiration times that fall within the corresponding time interval of such container;
wherein said at least one additional expiration informer tracks time intervals of the containers in the at least one additional set and causes to be removed the reference of at least one of the containers in the at least one additional set and the references to the objects in such container and located in the at least one additional repository at or near the end of the corresponding time interval of such container.

28. The system of claim 27, wherein each of said first and additional expiration informers provides a notification signal at or near the end of the time interval of a container tracked by such informer, said system further comprising a first and at least one additional listener that removes the reference(s) to objects in such container and located in the first or the at least one additional resource repository.

29. The system of claim 28, further comprising corresponding common resource objects in the first and the at least one additional resource repositories, said common objects being in corresponding containers having the same time interval tracked by the first and the at least one additional expiration informer, wherein the at least one additional application accesses resources available to the first application through reference of one of the common resource objects in the at least one additional resource repository and reference to such object in the first resource repository.

30. The system of claim 29, wherein said first and said at least one additional expiration informer cause to be removed the references to each of the common resource objects in the first and the at least one additional resource repositories at or near the end of the time interval of the containers containing such object, thereby freeing the resources available through such common resource object without requiring any communication between the first and said at least one additional expiration informers and applications.
